(19) United States
(12) Patent Application Publication
(10) Pub. No.: US 2006/0164381 A1
(43) Pub. Date: Jul. 27, 2006

(54) Reversible laptop computers

(76) Inventors: Mike Suk, San Jose, CA (US); Donald Ray Gillis, San Jose, CA (US)

Correspondence Address: Maryam Imam, Esq.;LAW OFFICES OF IMAM, Suite 1010, 111 North Market Street, San Jose, CA, 95113, US

(21) Appl. No.: 11/041,642

(22) Filed: Jan. 24, 2005

(51) Int. Cl. G09G 5/00

(52) U.S. Cl. 345/156

(57) ABSTRACT

A computer switching system is disclosed to include a switch for causing changing use of a portable computer keyboard and a portable computer mouse of a portable computer to use of the same by a non-portable computer, wherein the keyboard and mouse of the portable computer are utilized even when the portable computer is rendered inoperable.

### BACKGROUND OF THE INVENTION

1. Field of the Invention

This invention relates generally to the field of personal computers, portable and non-portable, and having a mouse, keyboard and monitor and more particularly, to switching use of the mouse, keyboard and monitor of a portable personal computer to use of the same for a non-portable personal computer.

2. Description of the Prior Art

In the advent of the popularity of personal computers, the use of laptop or portable personal computers has become particularly prevalent. However, portable personal computers have certain limitations, one of which is that they are not readily upgradable, as are non-portable or desktop computers. For example, the internal memory of a desktop computer can be easily increased by placing additional memory, purchased off-the-shelf and for a reasonable price. A portable personal computer however, has a limited number of slots in which additional memory can be placed due, in most part, to the small dimensions of the portable computer and the desire to maintain its small dimensions and to even make the latter smaller and smaller.

With the rapid advancement of technology, such as has been the case in the last couple of decades, the processing power and therefore memory and other requirements of computers has quickly increased therefore adding to the need and desirability of additional memory and processing speeds.

Processing speeds are set by the capability of central processing units (CPUs), which are again not readily changeable in portable computers, however, the keyboard, mouse and monitor (or video or screen) of a non-portable personal computer system maintains its effectiveness. Additionally, if a CPU is rendered inoperational, other components of a portable computer, such as its keyboard, mouse and monitor are likely to remain operational and therefore of use by another computer system, such as a non-portable computer system.

Additionally, the rate of change to or advancement of keyboard, monitor and mouse technology generally does not keep up with the rate of advancement of CPUs and memory, thus, a keyboard, mouse or monitor is likely to be desirable even if it is a part of an old portable computer. In fact, today, when a portable computer is considered obsolete, due to the foregoing reasons, rather than being upgraded, it is literally discarded and replaced with a new computer, which is a waste in view of its operational and rather desirable mouse, keyboard and monitor capabilities.

Desktop or non-portable computers are generally large in size and thus their use is generally considered undesirable in small work stations, such as home offices and the like. One of the reasons for their large size is a large keyboard and monitor. To add to this problem, oftentimes, users have a desktop or non-portable computer as well as a portable or laptop computer, which in some cases, consume nearly all of the user's work space.

Thus, the need arises for a switching system to allow use of the keyboard, mouse and/or monitor of a portable computer system by a desktop or non-portable personal computer thereby eliminating unnecessary waste of computer equipment and saving working space.

### SUMMARY OF THE INVENTION

Briefly, a computer switching system includes a switch for causing changing use of a portable computer keyboard and a portable computer mouse of a portable computer to use of the same by a non-portable computer, wherein the keyboard and mouse of the portable computer are utilized even when the portable computer is rendered inoperable.

### IN THE DRAWINGS

FIG. 1 shows a computer switching system 10 in accordance with an embodiment of the present invention.

FIG. 2 shows further details of the computer 12 of FIG. 1 including a switch 34.

FIG. 3 illustrates an alternative embodiment of the present invention wherein the switch 34 is located within the CPU 32 of the computer 12.

FIG. 4 shows yet another alternative embodiment of the present invention.

### DETAILED DESCRIPTION OF THE PREFERRED EMBODIMENT

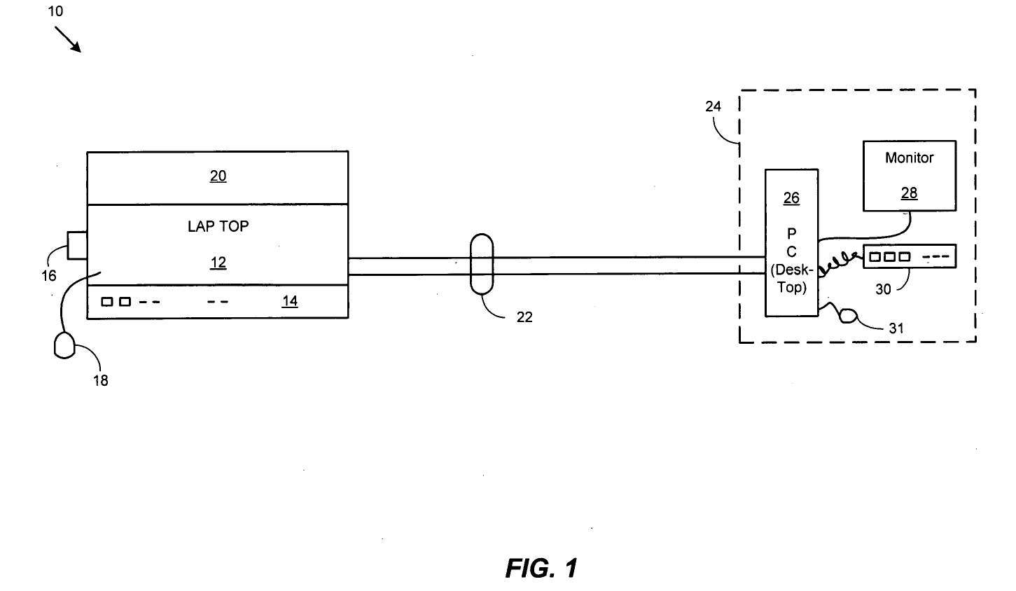

Referring now to FIG. 1, a computer switching system 10 is shown in accordance with an embodiment of the present invention to include a portable computer 12 coupled, through the cables 22, to a non-portable computer 24. The portable computer 12, in one example, is a laptop personal computer and the non-portable compute 24 in one example is a desktop personal computer.

The computer 12 is shown to include a laptop monitor 20, a laptop keyboard 14, a laptop mouse 18 and a switch button device 16. The laptop monitor 20, the laptop keyboard 14 and the laptop mouse 18 are well known to users of portable computers. The computer 24 is shown to include a personal computer 26, which is shown coupled to a desktop monitor 28 and a desktop keyboard 30 and a desktop mouse 31. The computer 24 and all of its components are known to users of desktop computers.

The switch button device 16, when depressed, along with a switch (not shown in FIG. 1) acts as a changing device for switching use of the laptop mouse 18, laptop keyboard 14 and/or laptop monitor 20 by the computer 12 to use of the same by the personal computer 26 in place of the desktop mouse, keyboard and/or monitor, respectively, through the cables 22.

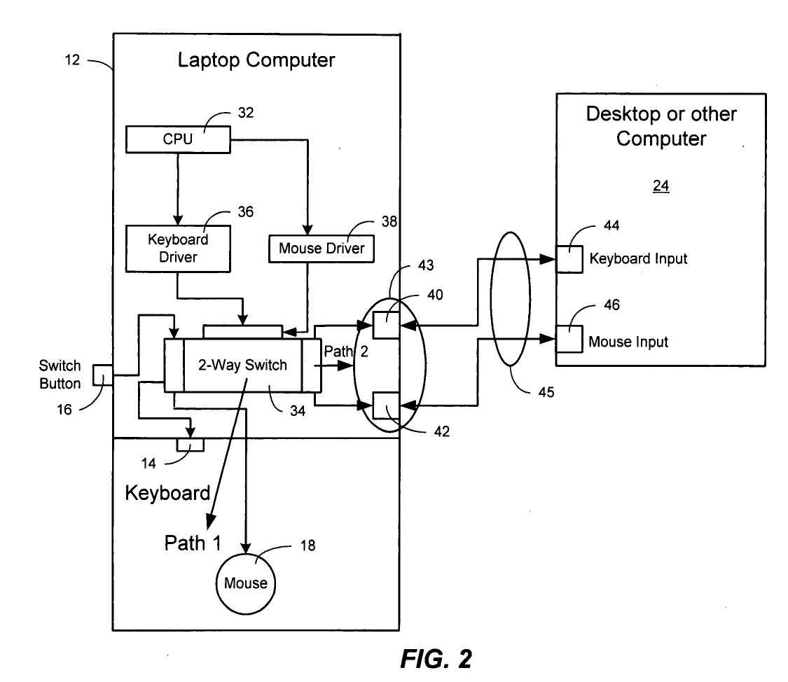

FIG. 2 shows further details of the computer 12 of FIG. 1. In FIG. 2, the computer 12 is shown to include a central processing unit (CPU) 32 coupled to a keyboard driver 36 and a mouse driver 38. The keyboard driver 36 and the mouse driver 38 are shown coupled to a switch 34 , which is responsive to input from the mouse driver 38, the keyboard 36 and the switch button device 16 and is shown to provide output for coupling to the keyboard 14, the mouse 18 and through a path 2, to ports 43. Ports 43 include a keyboard port 40 and a mouse port 42 through which cables 45 couple the keyboard 14 and the mouse 18 to a desktop keyboard port 44 and a desktop mouse port 46, respectively.

In operation, the CPU 32 controls the keyboard driver 36 and the mouse driver 38, which in turn, execute software or firmware to communicate with the keyboard 14 and the mouse 18, respectively. The switch 34 acts as a changing means switching use of the keyboard 14 and the mouse 18 by the computer 12 to use of the same by the computer 24. Normally, when the CPU 32 is in use, it communicates with the mouse 18 and the keyboard 14 with the mouse 18 being directly coupled to the mouse driver 38 and the keyboard 14 being directly coupled to the keyboard driver 36, through path 1.

However, when the CPU 32 is not in use, i.e. the computer 12 is not in operation, and the switch button device 16 is depressed, through path 2, the keyboard 14 and the mouse 18 are caused to be coupled to the keyboard port 44 and the mouse port 46, respectively, through the port 40 and the port 42, respectively. In the latter case, the mouse 18 and the keyboard 14 are utilized by the computer 24 and there is no electrical coupling from the keyboard 14 and the mouse 18 to the keyboard driver 36 and the mouse driver 38. When the switch button device 16 is depressed again, the direction of coupling changes back to path I with the CPU 32 accessing and being coupled to the mouse 18 and the keyboard 14 through the mouse driver 38 and the keyboard driver 36, respectively.

In path 2, the ports 40 and 42 are coupled to the ports 44 and 46, respectively, through the cables 45, thus, coupling the keyboard 14 and the mouse 18 to the ports 44 and 46, respectively. To this end, the computer 24 utilizes the keyboard 14 and the mouse 18 of the computer 12 and essentially, the switch 34 causes the coupling of the keyboard driver 36 to the keyboard 14 and the coupling of the mouse driver 38 to the mouse 18 of path 1 to be disconnected so that the computer 24 can use the keyboard 14 and the mouse 18.

In an alternative embodiment, the ports 40 and 42 are connected to a splitter thereby requiring only one cable from the computer 12 to the ports 44 and 46. In this manner, only one port of the ports 40 and 42 is required because the outputs from the switch 34 to the ports 44 and 46 will go through the splitter and then to the ports 44 and 46.

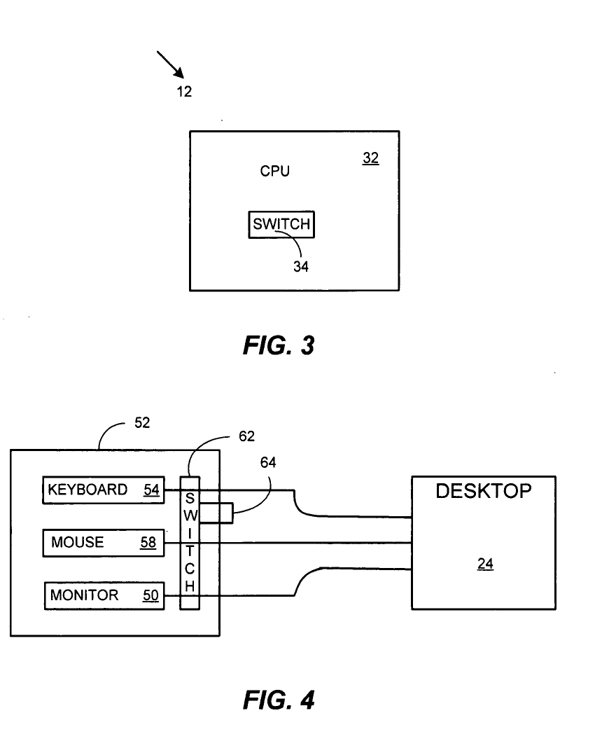

FIG. 3 shows an alternative embodiment of the present invention wherein the switch 34 is located within the CPU 32 of the computer 12. The switch 34 may be alternatively located anywhere within the electrical components of the computer 12.

FIG. 4 shows yet another alternative embodiment of the present invention wherein switching system 53 is shown to include a portable device 52 coupled to the computer 24 through a switch 62. The switch 62 is operated by a switch button device 64 similar to that of FIG. 1. In fact, the switch 62 functions similarly to the switch 34 of FIG. 1. That is, the switch 62 causes changing use of the keyboard 54, the mouse 58 and the monitor 50 to use of the same by the computer 24, wherein the keyboard, the mouse and the monitor of the portable device are utilized even when the portable device is rendered inoperable. The portable device 52 need not be a laptop and can rather be any portable electronic device that includes the components shown therein in FIG. 4. The device 52 is shown to include a keyboard 54, a mouse 58 and a monitor 50 for use by the computer 24. In this manner, the computer 24 utilizes not only the mouse 58 and keyboard 54 of the device 52, rather, the monitor 50 is also utilized by the computer 24.

This document includes copyrighted information with all rights reserved.

Although the present invention has been described in terms of specific embodiments, it is anticipated that alterations and modifications thereof will no doubt become apparent to those skilled in the art. It is therefore intended that the following claims be interpreted as covering all such alterations and modification as fall within the true spirit and scope of the invention.

What is claimed is:

1. A switch comprising changing means for causing changing of use of a portable computer keyboard and a portable computer mouse of a portable computer to use of the same by a non-portable computer, wherein the keyboard and mouse of the portable computer are utilized even when the portable computer is rendered inoperable.

2. A switch as recited in claim 1 wherein the switch is coupled to a switch button device so that the changing means switches when the button device is depressed.

3. A switch as recited in claim 1 wherein the switch is coupled to a portable computer keyboard port, the keyboard port used for coupling the keyboard to the non-portable computer.

4. A switch as recited in claim 3 wherein the switch is coupled to a portable computer mouse port, the mouse port being used for coupling the mouse to the non-portable computer.

5. A switch as recited in claim 4 wherein cables are employed for coupling the keyboard port and the mouse port to the non-portable computer.

6. A switch as recited in claim 5 including a splitter coupled to the keyboard port and the mouse port.

7. A computer switching system comprising:
a switch for causing changing use of a portable computer keyboard and a portable computer mouse of a portable computer to use of the same by a non-portable computer, wherein the keyboard and mouse of the portable computer are utilized even when the portable computer is rendered inoperable.

8. A computer switching system as recited in claim 7 wherein the switch is coupled to a switch button device so that the changing means switches when the button device is depressed.

9. A computer switching system as recited in claim 7 wherein the switch is coupled to a portable computer keyboard port, the keyboard port used for coupling the keyboard to the non-portable computer.

10. A computer switching system as recited in claim 9 wherein the switch is coupled to a portable computer mouse port wherein the mouse port, the mouse port used for coupling of the mouse to the non-portable computer.

11. A computer switching system as recited in claim 10 wherein cables are employed for coupling the keyboard port and the mouse port to the non-portable computer.

12. A computer switching system as recited in claim 11 including a splitter coupled to the keyboard port and the mouse port.

13. A computer switching system as recited in claim 7 wherein the switch is coupled to a keyboard driver and a mouse driver.

14. A computer switching system as recited in claim 13 wherein the keyboard driver and the mouse driver are coupled to a central processing unit (CPU).

15. A computer switching system as recited in claim 14 wherein the switch changes between states between a path 1 and a path 2 and when in path 1, the CPU is coupled to the keyboard and the mouse through the keyboard driver and the mouse driver, respectively, and when in path 2, the CPU is no longer coupled to the keyboard and the mouse.

16. A computer switching system as recited in claim 15 wherein when in path 2, the keyboard and the mouse are coupled to the non-portable computer for use therefor.

17. A switching system comprising:
a switch for causing changing use of a portable keyboard, a portable mouse and a portable monitor of a portable device to use of the same by a non-portable computer, wherein the keyboard, the mouse and the monitor of the portable device are utilized even when the portable device is rendered inoperable.

18. A method for changing use of a keyboard and mouse of a non-portable computer to use of the same by a portable computer comprising:
causing coupling of a switch to the keyboard and the mouse thereby forming a path 1;
causing coupling of the switch to the non-portable computer thereby forming a path 2; and
switching the coupling from path I to path 2.
